(19) United States
(12) Patent Application Publication
(10) Pub. No.: US 2025/0288486 A1
(43) Pub. Date: Sep. 18, 2025

(54) FOOT MASSAGE DEVICE WITH DUAL RIGID CLAMPING PLATES

(71) Applicant: Zhijun PENG, Foshan (CN)

(72) Inventor: Zhijun PENG, Foshan (CN)

(21) Appl. No.: 18/979,658

(22) Filed: Dec. 13, 2024

(30) Foreign Application Priority Data
Mar. 12, 2024 (CN) 2024102794945

(51) Int. Cl. A61H 23/02

(52) U.S. Cl. CPC A61H 23/0245; A61H 2201/105; A61H 2201/164; A61H 2201/165; A61H 2201/1692; A61H 2205/12; A61H 2209/00

(57) ABSTRACT

A foot massage device, including a bridge rigid clamping plate and a sole rigid clamping plate that are horizontally arranged, wherein the bridge rigid clamping plate is placed on top of the sole rigid clamping plate; front ends of the bridge rigid clamping plate and the sole rigid clamping plate as well as rear ends of the bridge rigid clamping plate and the sole rigid clamping plate are in each case connected via at least one binding belt; the foot massage device also has a at least two ultrasonic vibrators and some massage heads; through holes are formed on the sole rigid clamping plate and the bridge rigid clamping plate; each of the massage heads is detachably and adjustably mounted in a respective one of the through holes via threaded connection; the two ultrasonic vibrators are mounted on the bridge rigid clamping plate and the sole rigid clamping plate respectively.

### BACKGROUND OF THE INVENTION

The present invention relates to the field of massaging healthcare instruments, and in particular, to a foot massage device with dual rigid clamping plates.

There are many acupoints (acupuncture points) distributed on the feet of human body. According to traditional Chinese medicinal theories, the acupoints are associated with the internal organs of the human body. Blood circulation and metabolism of the human body can be promoted by massaging the acupoints of the feet. Frequent massage can eliminate fatigue, relieve nervousness, improve sleep, relax muscles, stimulate blood circulation, and improve immunity, thereby improving the general well-being of the human body.

With the development of modern science and technology, a numerous foot massagers that are targeted for massage-based healthcare of human feet have been developed. For example, CN218923176U (application Ser. No. 20/222,2372980.0) discloses a “FOLDABLE FOOT MASSAGING MACHINE” comprising a base, an upper cover, a foldable basin body, cloth bags, bridge and/or ankle massaging air bags, and sole massaging mechanisms with rotating wheels. During use, the massaging air bags are inflated and deflated to repeatedly press against the bridges and/or the ankles of the feet. Also, the massaging mechanisms with the rotating wheels are used to massage the soles of the human body, thereby promoting blood circulation and metabolism of the human body.

Although the foot massager in the above described prior art patent can massage the bridges and the soles of the feet, it has the following deficiencies during use: Firstly, massage positions on the bridges and the soles are fixed and cannot be adjusted freely by the user according to actual use requirements; as a result, the foot massager cannot be used flexibly. Secondly, the massaging air bags can only perform massage by applying uniform pressure around the feet; the massage positions cannot be selected according to actual use requirements; moreover, massage by applying air pressure against the feet is limited in force, which is furthermore non-adjustable. As a result, the use requirements of users for massage with different forces cannot be met. Thirdly, during massage, the feet have to be put into the cloth bags which are generally closed and provide poor air circulation, the soles may easily sweat, and thus leading to discomfort and possibly the problems of foot odor and athletic feet. In view of the foregoing deficiencies, the applicant of the present invention considers that this kind of foot massager has to be further improved to better satisfy daily massage-based healthcare needs.

### BRIEF SUMMARY OF THE INVENTION

To resolve the foregoing problems and deficiencies, the present invention provides a foot massage device with dual rigid clamping plates. The foot massage device of the present invention has good air permeability, so that the problems of sweating of the foot and thus the resulting problems of foot odor and athletic foot can be resolved. In addition, the massage heads can be detached. Therefore, the objective of adjusting positions of the massage heads can be achieved; use of the foot massage device is more versatile and convenient to meet the requirements of users for massaging different positions of the foot. Also, the force of the massage heads pressing against the foot can be adjusted due to threaded connection provided for connection of the massage heads to the respective through holes, so that the foot massage device can meet the use requirements of a majority of users.

A foot massage device, comprising a bridge rigid clamping plate and a sole rigid clamping plate, wherein the bridge rigid clamping plate is placed on top of the sole rigid clamping plate; front ends of the bridge rigid clamping plate and the sole rigid clamping plate as well as rear ends of the bridge rigid clamping plate and the sole rigid clamping plate are in each case connected via at least one binding belt so that the bridge rigid clamping plate and the sole rigid clamping plate are connected as a whole; a work cavity that can be narrowed and tightened by tightening said at least one binding belt between the front ends of the bridge rigid clamping plate and the sole rigid clamping plate and said at least one binding belt between the rear ends of the bridge rigid clamping plate and the sole rigid clamping plate is formed between the bridge rigid clamping plate and the sole rigid clamping plate; the foot massage device further comprises at least two ultrasonic vibrators and a plurality of massage heads; a plurality of through holes spaced apart from one another evenly by a same distance are formed on each of the sole rigid clamping plate and the bridge rigid clamping plate; each of at least one of said plurality of through holes on the sole rigid clamping plate and each of at least one of said plurality of through holes on the bridge rigid clamping plate are in each case detachably and adjustably mounted with one of said plurality of massage heads via threaded connection; said at least two ultrasonic vibrators are mounted on the bridge rigid clamping plate and the sole rigid clamping plate respectively, and when powered on, said at least two ultrasonic vibrators drive all massage heads on the bridge rigid clamping plate and the sole rigid clamping plate respectively to synchronously perform high-frequency vibratory massage.

Preferably, the rear end of the bridge rigid clamping plate extends upwards to form a shin clamping plate that corresponds to a shape of a shin; the rear end of the sole rigid clamping plate extends upwards to form a calf clamping plate that corresponds to a shape of a calf; a plurality of through holes spaced apart from one another evenly by a same distance are formed on each of the shin clamping plate and the calf clamping plate; each of at least one of said plurality of through holes on the shin clamping plate and each of at least one of said plurality of through holes on the calf clamping plate are in each case detachably and adjustably mounted with one of said plurality of massage heads via threaded connection.

Preferably, the shin clamping plate and the calf clamping plate are also connected via at least one binding belt.

Preferably, a concave cavity is formed in the middle of each of the bridge rigid clamping plate and the sole rigid clamping plate; each concave cavity is disposed with a corresponding one of said at least two ultrasonic vibrators, and a cover for protecting the corresponding one of said at least two ultrasonic vibrators is provided for each concave cavity to cover an opening of each concave cavity.

Preferably, a control panel is disposed on only one cover; a control circuit board electrically connected to a corresponding one of said at least two ultrasonic vibrators and said control panel is disposed on an inner side of each cover.

Preferably, each of the massage heads comprises a massage part with a surface featuring a plurality of massage protrusions, a screw part having one end connected to the massage part, and two tightening nuts; the screw part is selectively inserted into one of the through holes, and the two tightening nuts are screwed onto the screw part on both sides of said one of the through holes respectively, thereby allowing the screw part to be detachably and adjustably installed into said one of the through holes.

Preferably, a drug supply channel is provided on each of the massage heads penetrating from the surface of the massage part provided with the plurality of massage protrusions all the way through said one end of the screw part along an axial direction of the screw part through another end of the screw part; said another end of the screw part distal from the massage part is also provided with an interface part connected to the drug supply channel.

Preferably, the massage part is also provided with a recess, and the drug supply channel penetrates through a bottom surface of the recess; the plurality of massage protrusions are arranged circumferentially around the recess.

Preferably, support legs are further disposed at four corners of the sole rigid clamping plate.

The present invention has the following beneficial effects: (1) The front ends of the bridge rigid clamping plate and the sole rigid clamping plate as well as the rear ends thereof are in each case connected via at least one binding belt, so that the bridge rigid clamping plate and the sole rigid clamping plate are connected as a whole; a work cavity that can be narrowed and tightened by tightening said at least one binding belt between the front ends of the bridge rigid clamping plate and the sole rigid clamping plate and said at least one binding belt between the rear ends of the bridge rigid clamping plate and the sole rigid clamping plate is formed between the bridge rigid clamping plate and the sole rigid clamping plate. Accordingly, the work cavity is a breathable cavity with good air permeability; the problems of sweating of the foot and thus the resulting problems of foot odor and athletic foot are resolved; therefore the foot massage device is more comfortable to use.
(2) According to the present invention, the bridge rigid clamping plate and the sole rigid clamping plate are driven to vibrate at a high frequency by using the two ultrasonic vibrators, so that massage heads on the bridge rigid clamping plate and the sole rigid clamping plate are driven synchronously by their respective ultrasonic vibrators to perform high-frequency vibratory massage, thereby greatly reducing the quantities of ultrasonic vibrators to be used and the wiring required, simplifying the structure and manufacturing process, and saving electric energy.
(3) Because the massage heads are adjustably mounted in the through holes on the bridge rigid clamping plate and the sole rigid clamping plate via threaded connection, when the user wears the device, the force of the massage heads pressing against the foot can be adjusted by screwing the massage heads. Therefore, the massage heads can press tightly against the foot to provide a high-frequency ultrasonic vibratory massage with relatively strong force. This allows the user to adjust the pressing force of the massage heads based on his/her own needs, so that the foot massage device can meet the use requirements of a majority of users and has a wider scope of utility.
(4) Because the massage heads are detachably mounted in the through holes in the bridge rigid clamping plate and the sole rigid clamping plate via threaded connection, the massage heads can be detached and mounted in through holes corresponding to foot positions where massage is needed. Therefore, the objective of adjusting the vibration position freely is achieved; use of the foot massage device is very versatile and convenient; and massage requirements of users for different foot positions can be met effectively.

### BRIEF DESCRIPTION OF THE DRAWINGS

FIG. 1 is a schematic front perspective structural view of a foot massage device with dual rigid clamping plates according to the present invention.

FIG. 2 is a schematic rear perspective structural view of the foot massage device with dual rigid clamping plates according to the present invention.

FIG. 3 is a schematic sectional structure view along section A-A of FIG. 2.

### DETAILED DESCRIPTION OF THE INVENTION

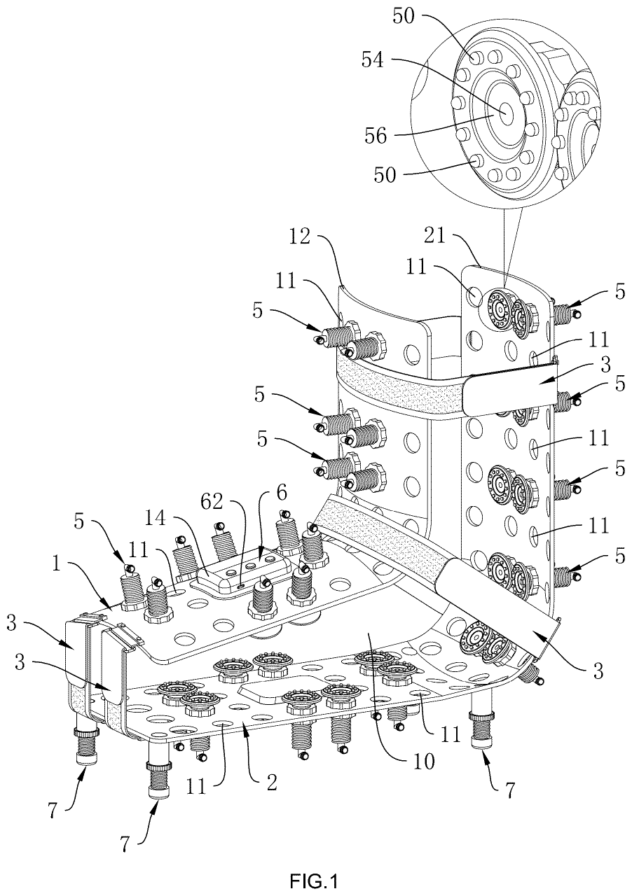

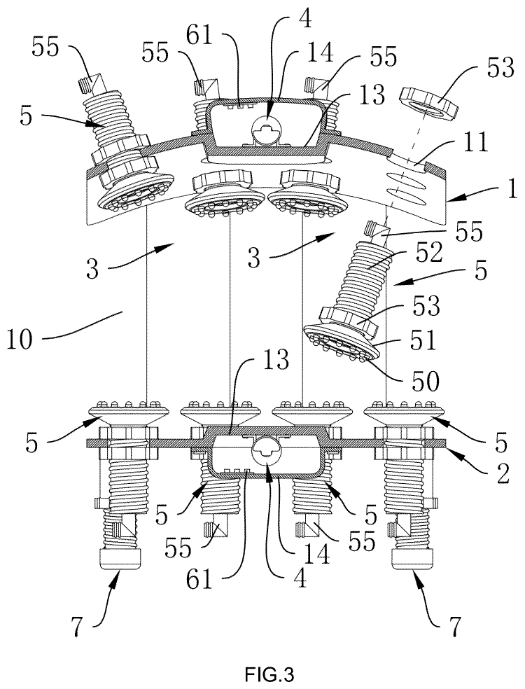

As shown in FIG. 1 and FIG. 3, the present invention provides a foot massage device with dual rigid clamping plates, comprising a bridge rigid clamping plate 1 and a sole rigid clamping plate 2, wherein the bridge rigid clamping plate 1 is placed on top of the sole rigid clamping plate 2; front ends of the bridge rigid clamping plate 1 and the sole rigid clamping plate 2 as well as rear ends of the bridge rigid clamping plate 1 and the sole rigid clamping plate 2 are in each case connected via at least one binding belt 3 so that the bridge rigid clamping plate 1 and the sole rigid clamping plate 2 are connected as a whole; a work cavity 10 that can be narrowed and tightened by tightening said at least one binding belt 3 between the front ends of the bridge rigid clamping plate 1 and the sole rigid clamping plate 2 and said at least one binding belt 3 between the rear ends of the bridge rigid clamping plate 1 and the sole rigid clamping plate 2 is formed between the bridge rigid clamping plate 1 and the sole rigid clamping plate 2; the work cavity 10 is where a foot of the user is accommodated, and since the work cavity 10 is adjustable by loosening or tightening the binding belts at the front and rear ends of the bridge rigid clamping plate 1 and the sole rigid clamping plate 2, the work cavity 10 is adaptable to different foot sizes, thereby ensuring snugged fit of the foot massage device on the user's foot as well as the stability and comfort of wearing the foot massage device. The foot massage device further comprises two ultrasonic vibrators 4 and a plurality of massage heads 5; a plurality of through holes 11 spaced apart from one another evenly by a same distance are formed on each of the sole rigid clamping plate 2 and the bridge rigid clamping plate 1. Each of at least one of said plurality of through holes 11 on the sole rigid clamping plate 2 and each of at least one of said plurality of through holes 11 on the bridge rigid clamping plate 1 are in each case detachably and adjustably mounted with one of said plurality of massage heads 5 via threaded connection; the two ultrasonic vibrators 4 are mounted on the bridge rigid clamping plate 1 and the sole rigid clamping plate 2 respectively, and when powered on, the two ultrasonic vibrators 4 drives all massage heads 5 on the bridge rigid clamping plate 1 and the sole rigid clamping plate 2 respectively to synchronously perform high-frequency vibratory massage. The foot massage device of the present invention has good air permeability, so that the problems of sweating of the foot and thus the resulting problems of foot odor and athletic foot can be resolved. In addition, the massage heads 5 can be detached. Therefore, the objective of adjusting positions of the massage heads 5 can be achieved; use of the foot massage device is more versatile and convenient to meet the requirements of users for massaging different positions of the foot. Also, the force of the massage heads 5 pressing against the foot can be adjusted due to threaded connection provided for connection of the massage heads 5 to the respective through holes 11, so that the foot massage device can meet the use requirements of a majority of users.

To enable the foot massage device of the present invention to also provide massage on the shin and calf so that the foot massage device can provide massages on more body parts, as shown in FIG. 1, the rear end of the bridge rigid clamping plate 1 extends upwards to form a shin clamping plate 12 that corresponds to a shape of a shin; the rear end of the sole rigid clamping plate 2 extends upwards to form a calf clamping plate 21 that corresponds to a shape of a calf; again, a plurality of through holes 11 spaced apart from one another evenly by a same distance are formed on each of the shin clamping plate 12 and the calf clamping plate 21; each of at least one of said plurality of through holes 11 on the shin clamping plate 12 and each of at least one of said plurality of through holes 11 on the calf clamping plate 21 are in each case detachably and adjustably mounted with one of said plurality of massage heads 5 via threaded connection. Due to the arrangement of the shin clamping plate 12 and the calf clamping plate 21, the foot massage device of the present invention has a shape of a long boot which enhances stability when being worn and is not easy to get loose. Moreover, through holes 11 of identical structures as those formed on the bridge rigid clamping plate 1 and the sole rigid clamping plate 2 are formed on each of the shin clamping plate 12 and the calf clamping plate 21, so that massage heads 5 can also be mounted in the through holes 11 of the shin clamping plate 12 and the calf clamping plate 21 for use. Therefore, the foot massage device of the present invention can also massage the shin and calf of the leg and hence fulfil the purpose of providing massages on more body parts, thereby further promoting blood circulation and metabolism of the human body.

As shown in FIG. 1, to reduce sharp corners on the foot massage device for the purpose of comfort during use, a connecting position between the shin clamping plate 12 and the rear end of the bridge rigid clamping plate 1 has an arc shape; a connecting position between the calf clamping plate 21 and the rear end of the sole rigid clamping plate 2 also has an arc shape. In this way, the foot massage device can fit the profiles of the ankle of the foot, sharp corners are reduced, and so it is more comfortable for the user to wear the foot massage device.

As shown in FIG. 1, in order to further enhance stability during use, such that the shin clamping plate 12 and the calf clamping plate 21 can tightly fixed to the shin and calf of the user, the shin clamping plate 12 and the calf clamping plate 21 are connected via at least one binding belt 3.

To avoid the two ultrasonic vibrators 4 from being exposed to an external environment, and to improve the surface tidiness and safety of use of the foot massage device, as shown in FIG. 3, a concave cavity 13 is formed in the middle of each of the bridge rigid clamping plate 1 and the sole rigid clamping plate 2, each concave cavity 13 is disposed with a corresponding one of the two ultrasonic vibrators 4, and a cover 14 for protecting the corresponding one of the ultrasonic vibrators 4 is provided for each concave cavity 13 to cover an opening of each concave cavity 13. The ultrasonic vibrators 4 can be encapsulated effectively by providing the covers 14 to achieve a dust-proof effect. Moreover, during use of the foot massage device of the present invention, the user will not easily touch the ultrasonic vibrators 4, so that the safety of use of the foot massage device is improved. In addition, the concave cavities 13 formed in the middle of the bridge rigid clamping plate 1 and the sole rigid clamping plate 2 respectively allow the high-frequency vibration of the two ultrasonic vibrators 4 on the bridge rigid clamping plate 1 and the sole rigid clamping plate 2 to be uniformly transferred to all positions of the bridge rigid clamping plate 1 and the sole rigid clamping plate 2 respectively, thereby ensuring that the vibration kinetic energy applied to the massage heads 5 on each of the bridge rigid clamping plate 1 and the sole rigid clamping plate 2 will be nearly the same, thereby ensuring that all massaging zones on the foot massage device can provide a relatively balanced ultrasonic vibratory massage effect. On the above basis, it is noted that massage heads 5 are also mounted on the through holes 11 on the shin clamping plate 12 and the calf clamping plate 21, therefore, in order that the vibration kinetic energy applied to the massage heads 5 on each of the shin clamping plate 12 and the calf clamping plate 21 will be nearly the same as the vibration kinetic energy applied to the massage heads 5 on each of the bridge rigid clamping plate 1 and the sole rigid clamping plate 2, the present invention may also provide the following additional features: additional ultrasonic vibrators 4 (not shown in the figures) which are structurally and functionally identical to the ultrasonic vibrators 4 on the bridge rigid clamping plate 1 and the sole rigid clamping plate 2 can be provided in the middle of the shin clamping plate 12 and the calf clamping plate 21 respectively, so that vibration kinetic energy massage received by the various massaging zones on the shin and calf is nearly the same as the vibration kinetic energy massage received by the various massaging zones on the foot.

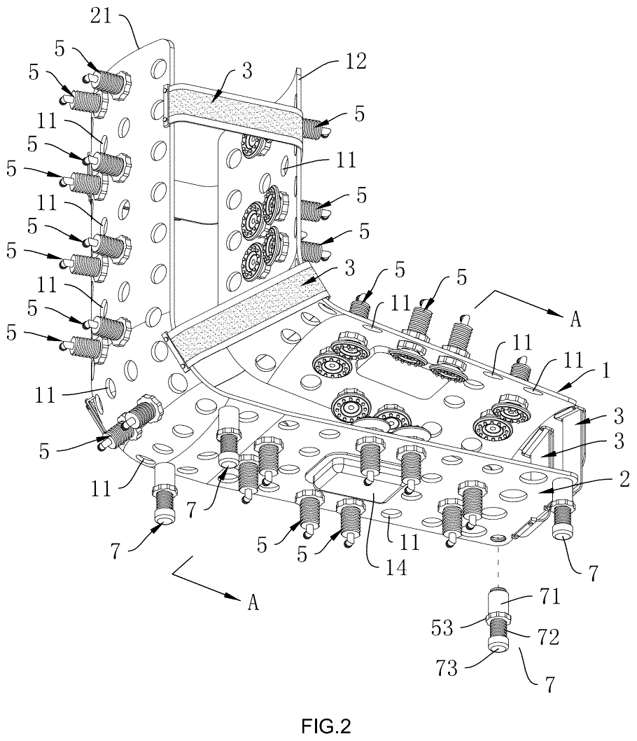

To facilitate the user to use the ultrasonic vibrators 4, as shown in FIG. 1, a control panel 6 is disposed on only one cover 14; a control circuit board 61 electrically connected to a corresponding one of the two ultrasonic vibrators 4 and said control panel 6 is disposed on an inner side of each cover 14. As shown in FIG. 1 and FIG. 2, in the present invention, the control panel 6 may be disposed only on the cover of the bridge rigid clamping plate 1; the ultrasonic vibrator 4 on the sole rigid clamping plate 2 that is not provided with the control panel 6 may be connected to the control panel 6 via wired or wireless connection so that the control panel 6 controls the operation of both the two ultrasonic vibrators 4 on the bridge rigid clamping plate 1 and the sole rigid clamping plate 2. Each of the two ultrasonic vibrators 4 is an ultrasonic vibration motor or an ultrasonic transducer. When the ultrasonic transducer is used, each control circuit board 61 of the present invention is further provided with an ultrasonic generator or an ultrasonic generating circuit; and the ultrasonic generator or the ultrasonic generating circuit drives the corresponding ultrasonic transducer to work.

As shown in FIG. 1 and FIG. 3, to facilitate power supply to different electric elements, each cover 14 is further provided with a power interface 62 electrically connected to a corresponding control circuit board 61. Of course, the foot massage device of the present invention can also be provided with storage batteries for power supply. In addition, a Bluetooth® communication module or a Wi-Fi® communication module can also be provided in each control circuit board 61, and corresponding application software can be developed and installed on a smartphone so that the foot massage device of the present invention can be controlled to operate by using the smartphone. Alternatively, an infrared communication module can be provided to each control circuit board 61, thereby allowing the foot massage device to be operated using a remote controller.

To ensure that the massage heads 5 are simple in structure, easy to implement, and convenient to produce and manufacture, as shown in FIG. 3, each of the massage heads 5 comprises a massage part 51 with a surface featuring a plurality of massage protrusions 50, a screw part 52 having one end connected to the massage part 51, and two tightening nuts 53; the screw part 52 is selectively inserted into one of the through holes 11, and the two tightening nuts 53 are screwed onto the screw part 52 on both sides of said one of the through holes 11 respectively, thereby allowing the screw part 52 to be detachably and adjustably installed into said one of the through holes 11. Through clamping by the two tightening nuts 53, each of the massage heads 5 can be securely installed on a corresponding one of the bridge rigid clamping plate 1 and the sole rigid clamping plate 2, making it less likely to be loosen or detached. As shown in FIG. 3, during detachment, it is only necessary to unscrew the tightening nut 53 proximal to an outer end (i.e. “another end” as described below) of the screw part 52 from the screw part 52, so that the screw part 52 can be detached from the through hole 11 and thereby removing the entire massage head 5 from the corresponding bridge rigid clamping plate 1 or the sole rigid clamping plate 2. When it is necessary to adjust the massage head 5 to press against the human body, adjustment can be achieved simply by holding the massage part 51 or the screw part 52 and then screwing the two tightening nuts 53 to adjust the positions of the two tightening nuts 53.

To increase the functionality of the foot massage device of the present invention, as shown in FIG. 1 and FIG. 3, a drug supply channel 54 is provided on each of the massage heads 5 penetrating from the surface of the massage part 51 provided with the plurality of massage protrusions 50 all the way through said one end of the screw part 52 along an axial direction of the screw part 52 through another end of the screw part 52; said another end of the screw part 52 distal from the massage part 51 is also provided with an interface part 55 connected to the drug supply channel 54. Through the design of the drug supply channel 54 and the interface part 35, the foot massage device of the present invention can be sold together with a drug supply device. The drug supply device is selectively connected to at least one interface part 55 through at least one pipeline, and drug solutions can be converted to gaseous drug by the drug supply device which then pumps the gaseous drug to at least one corresponding drug supply channel 54 through which the gaseous drug is sprayed onto the human body, thereby achieving a therapeutic effect through steaming of the gaseous drug. An example of the drug supply device 100 is mentioned in CN111939045A (application Ser. No. 20/191,0413695.9) also proposed by the inventor of the present invention.

As shown in FIG. 1 and FIG. 3, the massage part 51 is also provided with a recess 56, and the drug supply channel 54 penetrates through a bottom surface of the recess 56; the plurality of massage protrusions 50 are arranged circumferentially around the recess 56. Through these designs, an outlet of the drug supply channel 54 is prevented from being blocked by the skins and flesh of human body which may move and hence block the drug supply channel 54 when the massage part 51 presses against the human body to perform massage. Through the arrangement of the recess 56, the drug supply channel 54 is spaced apart from the human body to effectively prevent blockage of the drug supply channel 54. By arranging the massage protrusions 50 circumferentially around the recess 56, gaps between adjacent massage protrusions 50 facilitate the outward diffusion of the gaseous drug, thereby ensuring smooth outflow of the gaseous drug.

To prevent the massage heads 5 and the interface parts 55 on the sole rigid clamping plate 2 from pressing against the ground when the foot massage device is used on the ground, as shown in FIG. 1 and FIG. 2, support legs 7 are further disposed at four corners of the sole rigid clamping plate 2. In this way, damage and malfunctioning of the massage heads 5 and the interface parts 55 can be avoided. To facilitate pipeline connection between the interface parts 55 and the drug supply device 100, as shown in FIG. 3, a free end of each interface part 55 faces leftward or rightward.

As shown in FIG. 2, each of the support legs 7 is detachably connected to the sole rigid clamping plate 2 via threaded connection between an internal thread and an external thread. Specifically, the external thread is formed on each of the support legs 7; and the internal thread corresponding to each of the support legs 7 is formed on the sole rigid clamping plate 2. Of course, the internal thread may alternatively be formed on each of the support legs 7, and the external thread corresponding to each of the support legs 7 may alternatively be formed on the sole rigid clamping plate 2. Such detachable structural design facilitates machining and production of the support legs 7, and decreases the manufacturing difficulty of the sole rigid clamping plate 2. In addition, during packaging and transportation, the overall size of the foot massage device of the present invention can be decreased, so that the packaging material cost and the transportation cost can be decreased.

To allow a length of each of the support legs 7 to be adjustable during use such that the support legs 7 provides a height adjustment function to the foot massage device, as shown in FIG. 2, each of the support legs 7 comprises a fixing piece 71 with a screw hole, a support leg piece 73 with a screw rod 72, and a tightening nut 53 threaded to the screw rod 72. Specifically, the external thread is formed on the fixing piece 71. In this case, the foot massage device can be entirely lifted up or lowered down, or it can be obliquely disposed on the ground, so that during massage, a height and/or placement position of the user's foot relative to the ground can be adjusted. Therefore, different use requirements of users can be met.

As shown in FIG. 1, said at least one binding belt 3 connecting the front ends of the bridge rigid clamping plate 1 and the sole rigid clamping plate 2 comprises two binding belt 3. In this case, the bridge rigid clamping plate 1 and the sole rigid clamping plate 2 are connected more stably and will not easily get loose.

In a practical implementation of the present invention, in order to connect the shin clamping plate 12 and the calf clamping plate 21, one binding belt 3 is disposed between a left side of the calf clamping plate 21 and the shin clamping plate 12, and another binding belt 3 is disposed between a right side of the calf clamping plate 21 and the shin clamping plate 12. Alternatively, as shown in FIG. 1, only one binding belt 3 is used for connecting the shin clamping plate 12 and the calf clamping plate 21, wherein the binding belt 3 comprises a binding belt ring disposed on one side of the calf clamping plate 21 and a connecting belt disposed on another side of the calf clamping plate 21; a hook and loop fastener is disposed on an outer side surface of the connecting belt. The connecting belt extends from said another side of the calf clamping plate 21, binding a front side of the shin clamping plate 12, returns back to said one side of the calf clamping plate 21 where the binding belt ring is positioned, passes through the binding belt ring, and then folded back and adhered (via self-adhesion of the hook and loop fastener generally known in the art) back to the outer surface of the connecting belt, so that the shin clamping plate 12 is located between the binding belt 3 and the calf clamping plate 21. Similarly, the rear ends of the bridge rigid clamping plate 1 and the sole rigid clamping plate 2 may be analogously connected to each other through one or two binding belts 3 as in the case of the use of one or two binding belts to connect the shin clamping plate 12 and the calf clamping plate 21.

What is claimed is:

1. A foot massage device, comprising:
a bridge rigid clamping plate and a sole rigid clamping plate, wherein the bridge rigid clamping plate is placed on top of the sole rigid clamping plate; front ends of the bridge rigid clamping plate and the sole rigid clamping plate as well as rear ends of the bridge rigid clamping plate and the sole rigid clamping plate are in each case connected via at least one binding belt so that the bridge rigid clamping plate and the sole rigid clamping plate are connected as a whole; a work cavity that can be narrowed and tightened by tightening said at least one binding belt between the front ends of the bridge rigid clamping plate and the sole rigid clamping plate and said at least one binding belt between the rear ends of the bridge rigid clamping plate and the sole rigid clamping plate is formed between the bridge rigid clamping plate and the sole rigid clamping plate;
the foot massage device further comprises at least two ultrasonic vibrators and a plurality of massage heads; a plurality of through holes spaced apart from one another evenly by a same distance are formed on each of the sole rigid clamping plate and the bridge rigid clamping plate; each of at least one of said plurality of through holes on the sole rigid clamping plate and each of at least one of said plurality of through holes on the bridge rigid clamping plate are in each case detachably and adjustably mounted with one of said plurality of massage heads via threaded connection; said at least two ultrasonic vibrators are mounted on the bridge rigid clamping plate and the sole rigid clamping plate respectively, and when powered on, said at least two ultrasonic vibrators drive all the massage heads on the bridge rigid clamping plate and the sole rigid clamping plate respectively to synchronously perform high-frequency vibratory massage.

2. The foot massage device of claim 1, wherein the rear end of the bridge rigid clamping plate extends upwards to form a shin clamping plate that corresponds to a shape of a shin; the rear end of the sole rigid clamping plate extends upwards to form a calf clamping plate that corresponds to a shape of a calf; a plurality of through holes spaced apart from one another evenly by a same distance are formed on each of the shin clamping plate and the calf clamping plate; each of at least one of said plurality of through holes on the shin clamping plate and each of at least one of said plurality of through holes on the calf clamping plate are in each case detachably and adjustably mounted with one of said plurality of massage heads via threaded connection.

3. The foot massage device of claim 2, wherein the shin clamping plate and the calf clamping plate are also connected via at least one binding belt.

4. The foot massage device of claim 1, wherein a concave cavity is formed in the middle of each of the bridge rigid clamping plate and the sole rigid clamping plate; each concave cavity is disposed with a corresponding one of said at least two ultrasonic vibrators, and a cover for protecting the corresponding one of said at least two ultrasonic vibrators is provided for each concave cavity to cover an opening of each concave cavity.

5. The foot massage device of claim 4, wherein a control panel is disposed on only one cover; a control circuit board electrically connected to a corresponding one of said at least two ultrasonic vibrators and said control panel is disposed on an inner side of each cover.

6. The foot massage device of claim 1, wherein each of the massage heads comprises a massage part with a surface featuring a plurality of massage protrusions, a screw part having one end connected to the massage part, and two tightening nuts; the screw part is selectively inserted into one of the through holes, and the two tightening nuts are screwed onto the screw part on both sides of said one of the through holes respectively, thereby allowing the screw part to be detachably and adjustably installed into said one of the through holes.

7. The foot massage device of claim 6, wherein a drug supply channel is provided on each of the massage heads penetrating from the surface of the massage part provided with the plurality of massage protrusions all the way through said one end of the screw part along an axial direction of the screw part through another end of the screw part; said another end of the screw part distal from the massage part is also provided with an interface part connected to the drug supply channel.

8. The foot massage device of claim 7, wherein the massage part is also provided with a recess, and the drug supply channel penetrates through a bottom surface of the recess; the plurality of massage protrusions are arranged circumferentially around the recess.

9. The foot massage device of claim 1, wherein support legs are further disposed at four corners of the sole rigid clamping plate.

10. The foot massage device of claim 9, wherein each of the support legs is detachably connected to the sole rigid clamping plate via threaded connection.
